(19) United States
(12) Patent Application Publication
(10) Pub. No.: US 2003/0162689 A1
(43) Pub. Date: Aug. 28, 2003

(54) Conditioning preparation for fabric care

(76) Inventors: Tatiana Schymitzek, Krefeld (DE); Berthold Schreck, Duesseldorf (DE); Rainer Jeschke, Duesseldorf (DE); Josef Penninger, Hilden (DE); Pavel Gentschev, Duesseldorf (DE); Maren Jekel, Duesseldorf (DE); Karl-Heinz Scheffler, Duesseldorf (DE)

Correspondence Address: HENKEL CORPORATION, 2500 RENAISSANCE BLVD, STE 200, GULPH MILLS, PA, 19406, US

(21) Appl. No.: 10/328,680

(22) Filed: Dec. 23, 2002

Related U.S. Application Data
(60) Provisional application No. 60/351,878, filed on Jan. 25, 2002.

(51) Int. Cl. D06L 1/00; C11D 3/00

(52) U.S. Cl. 510/515

(57) ABSTRACT

The invention relates to a liquid fabric conditioner for fabric care and to the use of the conditioner in a washing or laundry drying process, to a conditioning substrate containing a liquid fabric conditioner, and to a conditioning process using the conditioning substrate in a laundry drying process. The liquid fabric conditioner and conditioning substrate are used to reduce fluff formation and pilling.

This invention relates to a conditioning preparation (conditioner) for fabric care and to the use of the conditioner in a washing or laundry drying process. The invention also relates to a conditioning substrate containing a conditioner and to a conditioning process using the conditioning substrate in a laundry drying process. The conditioner and conditioning substrate are used to reduce the formation of fluff and pills.

The use of conditioners and their application to carrier sheets for fabric conditioning in a household dryer have been known for some time. The conditioners normally contain cationic surfactants for imparting a pleasant softness to laundry and, optionally, fabric conditioning additives, such as creaseproofing additives, deodorizing substances and perfumes. The conditioners are applied to the carrier sheets by melting so that they can be released at the temperatures normally prevailing in a household dryer.

WO 00/24853 describes liquid fabric softener formulations containing crease-reducing components selected from silicone derivatives and sulfated or sulfonated vegetable oils and dryer sheets which contain one of these crease-reducing components.

EP 255 711 describes a conditioning sheet provided with a fabric conditioner containing cationic surfactants and polydiorganosiloxanes, the fabric conditioner having a melting point above 38° C.

U.S. Pat. No. 5,174,911 describes a fabric conditioning article for a laundry dryer, the conditioner which is applied to the article containing a fabric softening component and an aminosilicone component.

EP 317 135 discloses a water-based fabric softener formulation which contains a cationic and a nonionic fabric softener component. The nonionic fabric softener component is a special siloxane which contains at least one C₆₋₂₂ alkyl group.

EP 544 493 describes highly concentrated fabric softeners containing 60 to 99% by weight of a fabric-softening component and 1 to 40% by weight of an emulsified mixture of silicone oil and silicone emulsifier. The use of the emulsified silicone-containing mixture and the high percentage content of softener components ensures that phase separation of the components is avoided and that dryer sheets are uniformly coated. The conditioning composition for the dryer sheets has a melting point of 25 to 150° C. and, accordingly, is not liquid at room temperature.

However, the conditioners and conditioning sheets described in the prior art do not provide for fabric care. Modern fabric care makes high demands on the items of laundry. Thus, the washing of articles of clothing in an automatic washing machine and subsequent drying in a laundry dryer involve severe mechanical stressing of fabrics. The frictional forces often result in damage to the textile material reflected in fluff formation and pilling. Every wash and every drying cycle and also the wearing of the articles of clothing involve further abrasion and/or breakage of minute fibers on the surface of the textile material. Conventional conditioners and fabric care preparations are unable to reduce such fabric damage.

Accordingly, the problem addressed by the present invention was to reduce fluff formation and pilling in textiles, particularly during a washing or drying process.

It has surprisingly been found that the fluff formation and pilling of textiles can be considerably reduced by the use of certain components in conditioners.

In a first embodiment, therefore, the present invention relates to a conditioner containing at least one fluff-reducing component.

Conditioning in the context of the invention is understood to be the softening treatment of textile materials, yarns and woven fabrics. Conditioning provides the textiles with positive properties, such as for example an improved feel, increased luster and color brilliance, freshness, a reduction in creasing and static charging and easier ironing. In addition, conditioning in the context of the invention contributes to fabric care as reflected in reduced fluff formation and pilling.

The conditioners according to the invention contain at least one fluff-reducing component as a key component. Fluff-reducing components are present in the liquid conditioners according to the invention as fine polymer particles or polymer emulsions or polymer dispersions with a substantivity to textile materials or textile fibers. In a preferred embodiment, the polymers in question are water-insoluble polymers. Biological polymers are particularly preferred by virtue of their ready biodegradability and their excellent performance in reducing fluff formation. In the context of the invention, biological polymers are also polymers of only partly biological or biotechnological origin. However, biological polymers where at least 60%, preferably at least 80% and more particularly at least 90% of the molecular weight is of biological or biotechnological origin are preferred. Particularly preferred biological polymers are selected from the group of cellulose. Microcrystalline cellulose of natural origin, for example Arbocel® BE 600-10, Arbocel® BE 600-20 and Arbocel® BE 600-30 ex Rettenmaier, or of biotechnological origin, for example Cellulon® ex Kelco, are extremely preferred. Biotechnologically fermented celluloses which are described, for example, in U.S. Pat. No. 6,329,192 B1 are also suitable for use as a fluff-reducing component.

Cellulose derivatives are also suitable for use as fluff-reducing components. Examples are the alkylated and/or hydroxyalkylated polysaccharides, cellulose ethers, for example hydroxypropyl methyl cellulose (HPMC), ethyl(hydroxyethyl)cellulose (EHEC), hydroxypropyl cellulose (HPC), methyl cellulose (MC), propyl cellulose (PC), carboxymethyl methyl cellulose (CMMC), hydroxybutyl cellulose (HBC), hydroxybutyl methyl cellulose (HBMC), hydroxyethyl cellulose (HEC), hydroxyethyl carboxymethyl cellulose (HBMC), hydroxyethyl ethyl cellulose (HEEC), hydroxypropyl cellulose (HPC), hydroxypropyl carboxymethyl cellulose (HPCMC), hydroxyethyl methyl cellulose (HEMC), methyl hydroxyethyl cellulose (MHEC), methyl hydroxyethyl propyl cellulose (MHEPC) and mixtures thereof, methyl cellulose, methyl hydroxyethyl cellulose and methyl hydroxypropyl cellulose, hydroxypropyl cellulose and lightly ethoxylated MC or mixtures of the above-mentioned being preferred. Other examples are mixtures of cellulose ethers with carboxymethyl cellulose (CMC).

For the reduction of fluff formation and also for the absorption capacity of the cellulose derivatives, it has proved to be of advantage for at least 90% of the particles to have a particle size below 100 μm, preferably below 50 μm and more preferably below 20 μm.

Other suitable fluff-reducing components are hydrogels of biological polymers. Since hydrogels are water-containing systems based on hydrophilic but water-insoluble polymers which are present as a three-dimensional network, the particles on the textile surface after the drying process are much smaller and generally amount to only one tenth or less of their original volume. Suitable hydrogel dispersions are any hydrogels present as fine particles. Particularly suitable hydrogels are those where at least 90% of the particles have a particle size below 100 μm, preferably below 50 μm and more preferably below 20 μm. Hydrogels where at least 90% of the particles have a particle size below 500 nm are particularly suitable. Suitable hydrogels are natural polymers such as, for example, agarose, gelatine, curdlan, alginates, pectinates, carrageenans, chitosans, etc.

Improved absorption behavior of the hydrogel particles can additionally be achieved by subjecting them to cationic modification.

Networks are mainly formed through covalent bonds or through electrostatic, hydrophobic or dipole/dipole interactions.

The production of microscale and nanoscale hydrogels is known and has already been described in numerous publications.

Nanoscale hydrogel particles can be formed by microemulsion polymerization of a generally emulsifier-stabilized water/oil emulsion and homogenization by high-pressure homogenizers or rotor/stator homogenizers. The aqueous phase contains the dispersed polymers or monomers.

Synthetic polymers such as, for example, polyacrylates, polymethacrylates, polyacrylamides or polymethacrylamides, polyurethanes, polyvinyl pyrrolidones, polyvinyl alcohols, polyvinyl acetate and/or partial hydrolyzates or copolymers thereof may also be used.

The synthetic polymers may be added to the conditioners according to the invention as fine-particle powders or dispersions or, in a preferred embodiment, even as hydrogels.

The polycarboxylates have turned out to be particularly suitable. Polycarboxylates are, for example, the alkali metal salts of polyacrylic acid or polymethacrylic acid, for example those with a relative molecular weight of 500 to 1,000,000 g/mol and preferably in the range from 1,000 to 70,000 g/mol.

Suitable polymers are, in particular, polyacrylates which preferably have a molecular weight of 12,000 to 30,000 g/mol.

Other suitable polymers are copolymeric polycarboxylates, more particularly those of acrylic acid with methacrylic acid or of acrylic acid or methacrylic acid with maleic acid. Copolymers of acrylic acid with maleic acid which contain 50 to 90% by weight acrylic acid and 50 to 10% by weight maleic acid have proved to be particularly suitable. Their relative molecular weight, based on free acids, is generally in the range from 2,000 to 70,000 g/mol, preferably in the range from 15,000 to 50,000 g/mol and more particularly in the range from 30,000 to 40,000 g/mol. The (co)polymeric polycarboxylates may be used either as powders or in the form of an aqueous solution. Preferred commercially available products are present either in the form of aqueous solutions with solids contents of, for example, 30 to 40% or are spray-dried powders with a solids content of, for example, 90% by weight. For example, products of the Norasol® series (BASF) and products of the Acrysol® series (Rohm & Haas) may be used.

In their case, too, it has proved to be of advantage for fluff reduction if the preferably water-insoluble polymers are present as fine-particle powders. In a preferred embodiment, at least 90% of the particles have a particle size below 100 μm, preferably below 50 μm and more preferably below 20 μm.

Another important group of fluff-reducing components are the silicone oils.

Silicones oils corresponding to formulae I to III below have proved to be particularly suitable components.

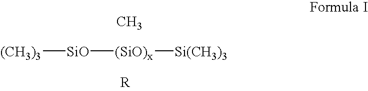

where R=phenyl or C₁₋₅ alkyl, preferably methyl, and x=5 to 100,000

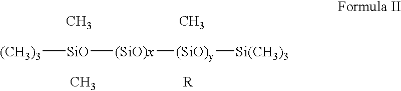

where R²=linear or branched alkyl containing 6 to 50 carbon atoms, the link to the Si atom being provided by an Si—O—C or —Si—C bond, or a linear or branched aminoalkyl group with x=0 to 10,000 and y=1 to 10,000.

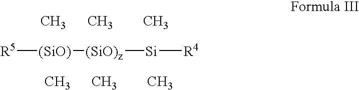

where R⁴ and R⁵ independently of one another represent linear or branched alkyl groups containing 6 to 50 carbon atoms. The links to the Si atoms are provided by C—Si or C—O—Si bonds. The number z is between 1 and 10,000.

The aminofunctionalized silicones such as, for example, aminopolydimethyl siloxanes are particularly suitable. The silicone oil derivatives may advantageously also contain ammonium groups because ammonium groups support absorption behavior on textile materials and yarns.

The silicone oils are advantageously present as emulsions where the mean droplet size is below 50 μm.

The conditioners according to the invention contain the fluff components in quantities of 0.005 to 15% by weight, preferably in quantities of 0.01 to 10% by weight, more preferably in quantities of 0.1 to 7% by weight and most preferably in quantities of 0.5 to 5% by weight, based on the conditioner as a whole.

The conditioners according to the invention advantageously contain at least one additional softener component for increasing the softness and for reducing the electrostatic charging of textile materials and yarns. Examples of such fabric-softening components are quaternary ammonium compounds, cationic polymers and emulsifiers of the type used in hair care preparations and also in fabric conditioners.

Suitable examples are quaternary ammonium compounds corresponding to formulae (I) and (II):

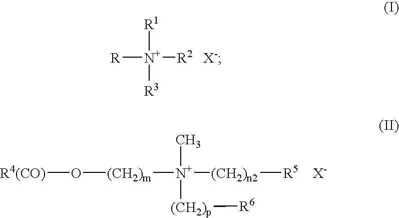

where R and R¹ in (I) represent an acyclic alkyl group containing 12 to 24 carbon atoms, R² is a saturated C₁₋₄ alkyl or hydroxyalkyl group, R³ is either the same as R, R¹ or R² or represents an aromatic radical. X⁻ is either a halide, methosulfate, methophosphate or phosphate ion or a mixture thereof. Examples of cationic compounds corresponding to formula (I) are didecyl dimethyl ammonium chloride, ditallow dimethyl ammonium chloride or dihexadecyl ammonium chloride.

Compounds corresponding to formula (II) are so-called esterquats. Esterquats are distinguished by excellent biodegradability. In that formula, R⁴ is an aliphatic alkyl group containing 12 to 22 carbon atoms and 0, 1, 2 or 3 double bonds, R⁵ is H, OH or O(CO)R⁷, R⁶ independently of R⁵ stands for H, OH or O(CO)R⁸, R⁷ and R⁸ independently of one another representing an aliphatic alkyl group containing 12 to 22 carbon atoms and 0, 1, 2 or 3 double bonds. m, n and p independently of one another can have a value of 1, 2 or 3. X⁻ can be a halide, methosulfate, methophosphate or phosphate ion or a mixture thereof. Preferred compounds contain the group O(CO)R⁷ for R⁵ and C₁₆₋₁₈ alkyl groups for R⁴ and R⁷. Particularly preferred compounds are those in which R⁶ is also OH. Examples of compounds corresponding to formula (II) are methyl-N-(2-hydroxyethyl)-N,N-di(tallowacyloxyethyl)-ammonium methosulfate, bis-palmitoyl)-ethyl hydroxyethyl methyl ammonium methosulfate or methyl-N,N-bis-(acyloxyethyl)-N-(2-hydroxyethyl)-ammonium methosulfate. If quaternized compounds corresponding to formula (II) containing unsaturated alkyl chains are used, the acyl groups of which the corresponding fatty acids have an iodine value of 5 to 80, preferably 10 to 60 and more particularly 15 to 45 and which have a cis-:trans-isomer ratio (in % by weight) of greater than 30:70, preferably greater than 50:50 and more particularly greater than 70:30 are preferred. Commercially available examples are the methyl hydroxyalkyl dialkoyloxyalkyl ammonium methosulfates marketed by Stepan under the name of Stepantex® or the Cognis products known under the name of Dehyquart® or the Goldschmidt-Witco products known under the name of Rewoquat®. Other preferred compounds are the diesterquats corresponding to formula (III) which are obtainable under the name of Rewoquat® W 222 LM or CR 3099 and, besides softness, also provide for stability and color protection.

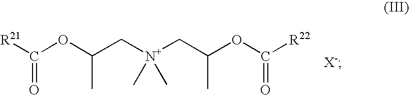

In formula (III), R²¹ and R²² independently of one another each represent an aliphatic group containing 12 to 22 carbon atoms and 0, 1, 2 or 3 double bonds.

Besides the quaternary compounds described above, other known compounds may also be used, including for example quaternary imidazolinium compounds corresponding to formula (IV):

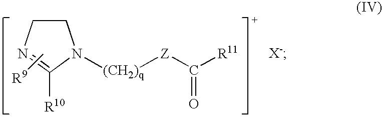

in which R⁹ represents H or a saturated alkyl group containing 1 to 4 carbon atoms, R¹⁰ and R¹¹ independently of one another represent an aliphatic, saturated or unsaturated alkyl group containing 12 to 18 carbon atoms, R¹⁰ alternatively may also represent O(CO)R²⁰, R²⁰ being an aliphatic, saturated or unsaturated alkyl group containing 12 to 18 carbon atoms, and Z is an NH group or oxygen and X⁻ is an anion. q may be an integer of 1 to 4.

Other suitable quaternary compounds correspond to formula (V):

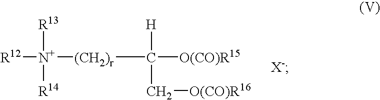

where R¹², R¹³ and R¹⁴ independently of one another represent a C14 alkyl, alkenyl or hydroxyalkyl group, R¹⁵ and R¹⁶ independently of one another represent a C₈₋₂₈ alkyl group and r is a number of 0 to 5.

Besides the compounds corresponding to formulae (I) and (II), short-chain, water-soluble quaternary ammonium compounds may also be used, including trihydroxyethyl methyl ammonium methosulfate or the alkyl trimethyl ammonium chlorides, dialkyl dimethyl ammonium chlorides and trialkyl methyl ammonium chlorides, for example cetyl trimethyl ammonium chloride, stearyl trimethyl ammonium chloride, distearyl dimethyl ammonium chloride, lauryl dimethyl ammonium chloride, lauryl dimethyl benzyl ammonium chloride and tricetyl methyl ammonium chloride.

Protonated alkylamine compounds with a fabric-softening effect and non-quaternized protonated precursors of the cationic emulsifiers are also suitable.

Other cationic compounds suitable for use in accordance with the invention are the quaternized protein hydrolyzates.

Suitable cationic polymers are the polyquaternium polymers listed in the CTFA Cosmetic Ingredient Dictionary (The Cosmetic, Toiletry and Fragrance Association, Inc., 1997), more particularly the polyquaternium-6, polyquaternium-7 and polyquaternium-10 polymers (Ucare Polymer IR 400, Amerchol) also known as merquats, polyquaternium-4 copolymers, such as graft copolymers with a cellulose skeleton and quaternary ammonium groups attached by allyl dimethyl ammonium chloride, cationic cellulose derivatives, such as cationic guar, such as guar hydroxypropyl triammonium chloride, and similar quaternized guar derivatives (for example Cosmedia Guar, Cognis GmbH), cationic quaternary sugar derivatives (cationic alkyl polyglucosides), for example the commercial product Glucquat®100 (CTFA name: Lauryl Methyl Gluceth-10 Hydroxypropyl Dimonium Chloride), copolymers of PVP and dimethyl aminomethacrylate, copolymers of vinyl imidazole and vinyl pyrrolidone, aminosilicon polymers and copolymers.

Polyquaternized polymers (for example Luviquat Care, BASF) and chitin-based cationic biopolymers and derivatives thereof, for example the polymer commercially obtainable as Chitosan® (Cognis), are also suitable.

Cationic silicone oils are also suitable for the purposes of the invention, including for example the commercially available products Q2-7224 (a stabilized trimethylsilyl amodimethicone, Dow Corning), Dow Corning 929 Emulsion (containing a hydroxylamino-modified silicone which is also known as amodimethicone), SM-2059 (General Electric), SLM-55067 (Wacker), Abil®-Quat 3270 and 3272 (diquaternary polydimethylsiloxanes, quaternium-80, Goldschmidt-Rewo) and siliconequat Rewoquat® SQ 1 (Tegopren® 6922, Goldschmidt-Rewo).

Other suitable compounds correspond to the following formula:

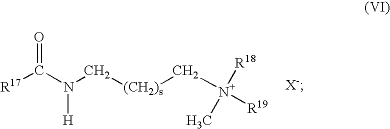

and may be alkylamidoamines in their non-quaternized form or, as illustrated, their quaternized form. In formula (VI), R¹⁷ may be an aliphatic alkyl group containing 12 to 22 carbon atoms and 0, 1, 2 or 3 double bonds. s may assume a value of 0 to 5. R¹⁸ and R¹⁹ independently of one another represent H, C₁₄ alkyl or hydroxyalkyl. Preferred compounds are fatty acid amidoamines, such as the stearylamidopropyl dimethylamine obtainable under the name of Tego Amid® S 18 or the 3-tallowamidopropyl trimethylammonium methosulfate obtainable as Stepantex® X 9124, which, besides a good conditioning effect, are also distinguished by a dye transfer inhibiting effect and by ready biodegradability. Particularly preferred compounds are alkylated quaternary ammonium compounds of which at least one alkyl chain is interrupted by an ester group and/or amido group, more particularly N-methyl-N-(2-hydroxyethyl)-N,N-(ditallowacyloxyethyl)-ammonium methosulfate and/or N-methyl-N-(2-hydroxyethyl)-N,N-(palmitoyloxyethyl)-ammonium methosulfate.

Suitable nonionic softeners are, above all, the polyoxyalkylene glycerol alkanoates described in GB 2,202,244, the polybutylenes described in GB 2,199,855, the long-chain fatty acids described in EP 13 780, the ethoxylated fatty acid ethanolamides described in EP 43 547, alkyl polyglycosides, more particularly the sorbitan mono-, di- and triesters described in EP 698 140 and the fatty acid esters of polycarboxylic acids described in DE 2 822 891.

The conditioners according to the invention may contain softener components in quantities of up to 50% by weight, preferably in quantities of 0.1 to 45% by weight, more preferably in quantities of 5 to 40% by weight and most preferably in quantities of 11 to 35% by weight, based on the conditioner as a whole.

In a preferred embodiment, the conditioner according to the invention additionally contains at least one easy-iron component. Easy-iron components in the context of the invention are substances whose effect on textile materials ensures that the textiles show little frictional resistance during ironing. Silicone oils have proved to be a particularly suitable easy-iron component.

Other easy-iron components are the partly oxidized polyethylenes.

Partly oxidized polyethylenes are understood to be predominantly linear polyethylene waxes which are products with relatively low molecular weights in the range from 500 to 50,000. The polyethylene waxes are generally produced by direct low-pressure polymerization or, preferably, high-pressure polymerization of the monomers or by selective depolymerization of relatively high molecular weight products. The modified polyethylene waxes used here may be produced by polymerization of ethylene, preferably in the absence of a catalyst, with early termination of polymerization and subsequent oxidation, for example by introduction of air or by copolymerization of ethylene with suitable other monomers, such as acrylic acid for example, the percentage content of acrylic acid units preferably not exceeding 20% and more particularly 10%. Finally, the dispersibility of polyolefins can be improved by oxidative surface treatment. Overviews on this subject can be found, for example, in Ullmanns Enzyklopädie der technischen Chemie, 4th Edition, 24, 36 and in Encycl. Polym. Sci. Eng. 17, 792 et seq.

The easy-iron component(s) may be present in quantities of up to 10% by weight, preferably 0.1 to 8% by weight and more particularly 0.5 to 5% by weight, based on the conditioner as a whole.

In a preferred embodiment, the conditioners according to the invention contain at least one spreading component. The spreading component has a wetting function and an effect whereby the other components are optimally distributed over a large area. This ensures that there are no partial overconcentrations on the textile surface that would be visible as stains. The use of spreading agents is particularly recommended where conditioning substrates impregnated with the conditioner according to the invention are used in a laundry drying process.

Suitable spreading agents are polyether-modified siloxanes corresponding, for example, to formulae IV and V:

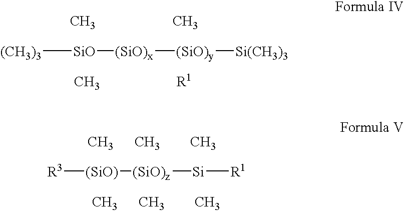

The substituents R¹ and R³ in formulae IV and V independently of one another represent —R^{r}—(C₂H₄O)ₘ—(C₃H₆O)ₙ—R⁶ where

R^{r} is a difunctional alkylene group, for example —CH₂— or —C₂H₄—,

R⁶=H, methyl or C₂₋₆ alkyl,

x and y each have a value of 1 or more, the sum of x+y being up to 10,000,

z is between 1 and 10,000,

m and n may assume values of 0 to 300, the sum of m+n being 1 to 300.

The spreading agents may be present in quantities of up to 10% by weight, preferably 0.01 to 5% by weight, more preferably 0.05 to 2% by weight and most preferably 0.1 to 1% by weight, based on the conditioner as a whole.

The conditioners according to the invention are present in liquid form. To achieve a liquid consistency, it may be advisable to use both liquid organic solvents and also water. Accordingly, the conditioners according to the invention optionally contain solvent.

Solvents which may be used in the preparations according to the invention belong, for example, to the group of mono- or polyhydric alcohols, alkanolamines or glycol ethers providing they are miscible with water in the stated concentration range. The solvents are preferably selected from ethanol, n- or i-propanol, butanols, glycol, propane or butane diol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, butoxypropoxy butanol (BPP), dipropylene glycol monomethyl or monoethyl ether, diisopropylene glycol monomethyl or monoethyl ether, methoxy, ethoxy or butoxy triglycol, 1-butoxyethoxy-2-propanol, 3-methyl-3-methoxybutanol, propylene glycol-t-butyl ether and mixtures of these solvents.

Some glycol ethers are commercially obtainable under the names of Arcosolv® (Arco Chemical Co.) or Cellosolve®, Carbitol® or Propasol® (Union Carbide Corporation); these glycol ethers also include, for example, ButylCarbitol®, HexylCarbitol®, MethylCarbitol® and Carbitol® itself, (2-(2-ethoxy)-ethoxy)-ethanol. The glycol ether may readily be selected by the expert on the basis of its volatility, its solubility in water, its percentage by weight in the dispersion as a whole and the like. Pyrrolidone solvents, such as N-alkyl pyrrolidones, for example N-methyl-2-pyrrolidone or N-C₈₋₁₂-alkyl pyrrolidone, or 2-pyrrolidone, may also be used. In addition, glycerol derivatives, more particularly glycerol carbonate, are preferably used as sole solvent or as part of a solvent mixture.

Alcohols which may be used as co-solvents for the purposes of the present invention include liquid polyethylene glycols of low molecular weight, for example polyethylene glycols with a molecular weight of 200, 300, 400 or 600. Other suitable co-solvents are other alcohols, for example (a) lower alcohols, such as ethanol, propanol, isopropanol and n-butanol, (b) ketones, such as acetone and methylethyl ketone, (c) C₂₋₄ polyols, such as a diol or a triol, for example ethylene glycol, propylene glycol, glycerol or mixtures thereof. Among the diols, octane-1,2-diol is particularly preferred.

In a preferred embodiment, the conditioner according to the invention may contain one or more water-soluble organic solvents and/or water. Water-soluble in the present context means that the organic solvent is soluble in the quantity present in an optionally aqueous medium.

In a preferred embodiment, the conditioner according to the invention contains one or more solvents from the group consisting of C₁₋₄ monoalcohols, C₂₋₆ glycols, C₃₋₁₂ glycol ethers and glycerol, more particularly ethanol. The C₃₋₁₂ glycol ethers according to the invention contain alkyl or alkenyl groups with fewer than 10 carbon atoms, preferably up to 8, more preferably up to 6, most preferably 1 to 4 and, in one most particularly preferred embodiment, 2 to 3 carbon atoms.

Preferred C₁₋₄ monoalcohols are ethanol, n-propanol, isopropanol and tert.butanol. Preferred C₂₋₅ glycols are ethylene glycol, 1,2-propylene glycol, 1,3-propylene glycol, 1,5-pentanediol, neopentyl glycol and 1,6-hexanediol, more particularly ethylene glycol and 1,2-propylene glycol. Preferred C₃₋₁₂ glycol ethers are di-, tri-, tetra- and pentaethylene glycol, di-, tri- and tetrapropylene glycol, propylene glycol monotert.butyl ether and propylene glycol monoethyl ether and the solvents known under INCI nomenclature as butoxydiglycol, butoxyethanol, butoxyisopropanol, butoxypropanol, butyloctanol, ethoxydiglycol, ethoxyethanol, ethyl hexanediol, isobutoxypropanol, isopentyldiol, 3-methoxybtuanol, methoxyethanol, methoxyisopropanol and methoxymethylbutanol.

Particularly preferred solvents are ethanol, 1,2-propylene glycol and dipropylene glycol and mixtures thereof, more particularly ethanol and isopropanol.

The conditioner according to the invention optionally contains one or more solvents and/or, in particular, water in a quantity of typically up to 95% by weight, preferably 20 to 90% by weight and more particularly 50 to 80% by weight, based on the conditioner as a whole.

In a preferred embodiment, the conditioners according to the invention may additionally contain nonionic surfactants. The nonionic surfactants have excellent emulsifying properties, particularly in the presence of cationic surfactants.

Preferred nonionic surfactants are alkoxylated, advantageously ethoxylated and/or propoxylated, more particularly primary alcohols preferably containing 8 to 18 carbon atoms and an average of 1 to 12 mol ethylene oxide (EO) and/or 1 to 10 mol propylene oxide (PO) per mol alcohol. C₈₋₁₆ alcohol alkoxylates, advantageously ethoxylated and/or propoxylated C₁₀₋₁₅ alcohol alkoxylates, more particularly C₁₂₋₁₄ alcohol alkoxylates, with a degree of ethoxylation of 2 to 10, preferably 3 to 8, and/or a degree of propoxylation of 1 to 6, preferably 1.5 to 5, are particularly preferred. The alcohol radical may preferably be linear or, more preferably, 2-methyl-branched or may contain linear and methyl-branched radicals in the form of the mixtures typically present in oxoalcohol radicals. However, alcohol ethoxylates containing linear radicals of alcohols of native origin with 12 to 18 carbon atoms, for example coconut oil fatty alcohol, palm oil fatty alcohol, tallow fatty alcohol or oleyl alcohol, and an average of 2 to 8 EO per mol alcohol are particularly preferred. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 5 EO. The degrees of ethoxylation and propoxylation mentioned are statistical mean values which, for a special product, may be either a whole number or a broken number. Preferred alcohol ethoxylates and propoxylates have a narrow homolog distribution (narrow range ethoxylates/propoxylates, NRE/NRP). In addition to these nonionic surfactants, fatty alcohols containing more than 12 EO may also be used, as described above. Examples of such fatty alcohols are tallow fatty alcohols containing 14 EO, 25 EO, 30 EO or 40 EO.

Other suitable nonionic surfactants are alkoxylated amines, advantageously ethoxylated and/or propoxylated, more particularly primary and secondary amines preferably containing 1 to 18 carbon atoms per alkyl chain and, on average, 1 to 12 mol ethylene oxide (EO) and/or 1 to 10 mol propylene oxide (PO) per mol amine.

In addition, alkyl glycosides with the general formula RO(G)ₓ, where R is a primary, linear or methyl-branched, more particularly 2-methyl-branched, aliphatic radical containing 8 to 22 and preferably 12 to 18 carbon atoms and G is a glycose unit containing 5 or 6 carbon atoms, preferably glucose, for example as compounds, more particularly with anionic surfactants, may be used as other nonionic surfactants. The degree of oligomerization x, which indicates the distribution of mono- and oligoglycosides, is a number of 1 to 10; preferably x=1.2 to 1.4.

Another class of preferred nonionic surfactants which are used either as sole nonionic surfactant or in combination with other nonionic surfactants, are alkoxylated, preferably ethoxylated or ethoxylated and propoxylated, fatty acid alkyl esters preferably containing 1 to 4 carbon atoms in the alkyl chain, more particularly the fatty acid methyl esters which are described, for example, in Japanese patent application JP 58/217598 or which are preferably produced by the process described in International patent application WO-A-90/13533.

Nonionic surfactants of the amine oxide type, for example N-cocoalkyl-N,N-dimethylamine oxide and N-tallowalkyl-N,N-dihydroxyethyl amine oxide, and the fatty acid alkanolamide type are also suitable.

Other suitable surfactants are so-called gemini surfactants. Gemini surfactants are generally understood to be compounds which contain two hydrophilic groups and two hydrophobic groups per molecule. These groups are generally separated from one another by a so-called “spacer”. The spacer is generally a carbon chain which should be long enough for the hydrophilic groups to have a sufficient spacing to be able to act independently of one another. Gemini surfactants are generally distinguished by an unusually low critical micelle concentration and by an ability to reduce the surface tension of water to a considerable extent. In exceptional cases, however, gemini surfactants are not only understood to be dimeric surfactants, but also trimeric surfactants.

Suitable gemini surfactants are, for example, the sulfated hydroxy mixed ethers according to German patent application DE-A-43 21 022 and the dimer alcohol bis- and trimer alcohol tris-sulfates and -ether sulfates according to International patent application WO-A-96/23768. The end-capped dimeric and trimeric mixed ethers according to German patent application DE-A-195 13 291 are distinguished in particular by their bifunctionality and multifunctionality. Thus, the end-capped surfactants mentioned exhibit good wetting properties and are low-foaming so that they are particularly suitable for use in machine washing or cleaning processes.

However, the gemini polyhydroxyfatty acid amides or poly-polyhydroxyfatty acid amides described in International patent applications WO-A-95/19953, WO-A-95/19954 and WO-A-95/19955 may also be used.

Other suitable surfactants are polyhydroxyfatty acid amides corresponding to the following formula:

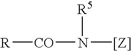

in which RCO is an aliphatic acyl radical containing 6 to 22 carbon atoms, R⁵ is hydrogen, an alkyl or hydroxyalkyl radical containing 1 to 4 carbon atoms and [Z] is a linear or branched polyhydroxyalkyl radical containing 3 to 10 carbon atoms and 3 to 10 hydroxyl groups. The polyhydroxyfatty acid amides are known compounds which may normally be obtained by reductive amination of a reducing sugar with ammonia, an alkylamine or an alkanolamine and subsequent acylation with fatty acid, a fatty acid alkyl ester or a fatty acid chloride.

The group of polyhydroxyfatty acid amides also includes compounds corresponding to the following formula:

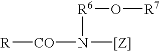

in which R is a linear or branched alkyl or alkenyl group containing 7 to 12 carbon atoms, R⁶ is a linear, branched or cyclic alkyl group or an aryl group containing 2 to 8 carbon atoms and R⁷ is a linear, branched or cyclic alkyl group or an aryl group or a hydroxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated, derivatives of such a group.

[Z] is preferably obtained by reductive amination of a reducing sugar, for example glucose, fructose, maltose, lactose, galactose, mannose or xylose. The N-alkoxy or N-aryloxy-substituted compounds may then be converted into the required polyhydroxyfatty acid amides by reaction with fatty acid methyl esters in the presence of an alkoxide as catalyst, for example in accordance with the teaching of International patent application WO-A-95/07331.

The nonionic surfactants may normally be used in quantities of up to 20% by weight, preferably 0.5 to 10% by weight and more particularly in quantities of 0.8 to 5% by weight, based on the conditioner as a whole.

In another preferred embodiment, the conditioners according to the invention optionally contain electrolytes as an additional ingredient. Electrolytes are used for viscosity adjustment (viscosity adjusters) and may normally be used in quantities of up to 15% by weight, preferably up to 10% by weight, more preferably 0.5 to 8% by weight and most preferably 1 to 6% by weight, based on the conditioner as a whole.

A broad range of various salts may be used as electrolytes from the group of inorganic salts. Preferred cations are the alkali metal and alkaline earth metal salts; preferred anions are the halides and sulfates. From the production perspective, NaCl, CaCl₂ and MgCl₂ are preferably used in the conditioners according to the invention.

In order to bring the pH value of the conditioners according to the invention into the required range, it may be advisable to use pH adjusters. Any known acids and alkalis may be used for this purpose providing their use is not technically or ecologically unsafe or unsafe on consumer protection grounds. The quantity of pH adjuster used normally does not exceed 2% by weight, based on the formulation as a whole.

The conditioners according to the invention have a pH value of 2 to 7, preferably 2.2 to 5 and more particularly 2.4 to 3.

Besides relatively small quantities of anionic and amphoteric surfactants, the conditioners according to the invention may optionally contain one or more typical auxiliaries and additives, more particularly from the group of builders, enzymes, complexing agents, perfumes, perfume carriers, fluorescent whitening agents, dyes, thickeners, foam inhibitors, redeposition inhibitors, creaseproofing additives, antimicrobial agents, germicides, fungicides, antioxidants, antistatics, UV absorbers, optical brighteners, pearlizers, dye transfer inhibitors, shrinkage inhibitors, corrosion inhibitors, preservatives, waterproofing and impregnating agents and hydroptropes.

In a preferred embodiment, the composition according to the invention may additionally contain one or more complexing agents.

Complexing agents (INCI Chelating Agents), also known as sequestering agents, are ingredients which are capable of complexing and inactivating metal ions in order to prevent their adverse effects on the stability or the appearance of the composition, for example clouding. On the one hand, it is important to complex the calcium and magnesium ions responsible for water hardness which are incompatible with many ingredients. The complexing of the ions of heavy metals, such as iron or copper, delays the oxidative decomposition of the final composition.

Suitable complexing/sequestering agents are, for example, the following complexing/sequestering agents referred to by their INCI names which are described in more detail in the International Cosmetic Ingredient Dictionary and Handbook: Aminotrimethylene Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Preferred complexing/sequestering agents are tertiary amines, more particularly tertiary alkanolamines (aminoalcohols). The alkanolamines contain both amino groups and also hydroxy and/or ether groups as functional groups. Particularly preferred tertiary alkanolamines are triethanolamine and tetra-2-hydroxypropyl ethylenediamine (N,N,N′,N′-tetrakis-(2-hydroxypropyl)-ethylenediamine).

A particularly preferred complexing/sequestering agent is etidronic acid (1-hydroxyethylidene-1,1-diphosphonic acid, 1-hydroxyethane-1,1-diphosphonic acid, HEDP, acetophosphonic acid, INCI Etidronic Acid), including its salts. In one preferred embodiment, therefore, the composition according to the invention contains etidronic acid and/or one or more of its salts as complexing/sequestering agent.

In one particular embodiment, the composition according to the invention contains a complexing/sequestering agent combination of one or more tertiary amines and one or more other complexing/sequestering agents, preferably one or more complexing/sequestering acids and/or salts thereof, more particularly of triethanolamine and/or tetra-2-hydroxypropyl ethylenediamine and etidronic acid and/or one or more of its salts.

The conditioner according to the invention contains complexing/chelating agents in a quantity of normally 0 to 20% by weight, preferably 0.1 to 15% by weight, more preferably 0.5 to 10% by weight, most preferably 1 to 8% by weight and, in one most particularly preferred embodiment, 1.5 to 6% by weight, for example 1.5, 2.1, 3 or 4.2% by weight.

In another embodiment, the conditioner optionally contains one or more thickeners.

The viscosity of the optionally liquid conditioners may be measured by typical standard methods (for example Brookfield viscosimeter RVD-VII at 20 r.p.m./20° C., spindle 3) and is preferably in the range from 10 to 5,000 mPas. Preferred liquid to gel-form conditioners have viscosities of 20 to 4,000 mPas, values of 40 to 2,000 mPas being particularly preferred. If the conditioners according to the invention are used as impregnating liquids for the conditioning substrates according to the invention, a viscosity below 150 mPas, preferably in the range from 10 to 100 mPas and more particularly in the range from 20 to 80 mPas being appropriate.

Suitable thickeners are inorganic or polymeric organic compounds. Mixtures of several thickeners may also be used.

In another preferred embodiment, the conditioner optionally contains one or more enzymes.

Suitable enzymes are, in particular, enzymes from the classes of hydrolases, such as proteases, esterases, lipases or lipolytic enzymes, amylases, cellulases or other glycosyl hydrolases and mixtures thereof. All these hydrolases contribute to the removal of stains, such as protein-containing, fat-containing or starch-containing stains, and discoloration in the washing process. In a particularly preferred embodiment, the conditioners according to the invention additionally contain cellulases and/or other glycosyl hydrolases. These enzymes can contribute towards color retention and towards increasing fabric softness by removing pilling and microfibrils. Oxidoreductases may also be used for bleaching and for inhibiting dye transfer.

Enzymes obtained from bacterial strains or fungi, such as Bacillus subtilis, Bacillus licheniformis, Streptomyces griseus and Humicola insolens are particularly suitable. Proteases of the subtilisin type are preferably used, proteases obtained from Bacillus lentus being particularly preferred. Of particular interest in this regard are enzyme mixtures, for example of protease and amylase or protease and lipase or lipolytic enzymes or protease and cellulase or of cellulase and lipase or lipolytic enzymes or of protease, amylase and lipase or lipolytic enzymes or protease, lipase or lipolytic enzymes and cellulase, but especially protease- and/or lipase-containing mixtures or mixtures with lipolytic enzymes. Examples of such lipolytic enzymes are the known cutinases. Peroxidases or oxidases have also been successfully used in some cases. Suitable amylases include in particular α-amylases, isoamylases, pullanases and pectinases. Preferred cellulases are cellobiohydrolases, endoglucanases and β-glucosidases, which are also known as cellobiases, and mixtures thereof. Since the various cellulase types differ in their CMCase and avicelase activities, the desired activities can be established by mixing the cellulases in the appropriate ratios.

The enzymes may be adsorbed to supports and/or encapsulated in membrane materials to protect them against premature decomposition. The percentage content of enzymes, enzyme mixtures or enzyme granules may be, for example, about 0.1 to 5% by weight and is preferably from 0.12 to about 2% by weight.

In a preferred embodiment, the conditioner optionally contains one or more perfumes in a quantity of typically up to 10% by weight, preferably 0.01 to 5% by weight, more preferably 0.05 to 3% by weight, most preferably 0.2 to 2% by weight and, in one most particularly preferred embodiment, 0.3 to 1.8% by weight.

Suitable perfume oils or perfumes include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes which together produce an attractive perfume note are preferably used. Perfume oils such as these may also contain natural perfume mixtures obtainable from vegetable sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

Dyes may optionally be used in the conditioner according to the invention, the quantity of one or more dyes being having to be so small that no visible residues remain after application of the conditioner. However, the conditioner according to the invention is preferably free from dyes.

The conditioner according to the invention may optionally contain one or more antimicrobial agents or preservatives in a quantity of normally 0.0001 to 3% by weight, preferably 0.0001 to 2% by weight, more preferably 0.0002 to 1% by weight, most preferably 0.0002 to 0.2% by weight and, in one most particularly preferred embodiment, 0.0003 to 0.1% by weight. The use of antimicrobial agents for destroying the bacteria present on the substrates may be advisable, particularly in cases where the conditioner according to the invention is used as an impregnating liquid for the conditioning substrates according to the invention. Depending on the antimicrobial spectrum and the action mechanism, antimicrobial agents or preservatives are classified as bacteriostatic agents and bactericides, fungistatic agents and fungicides, etc. Important representatives of these groups are, for example, benzalkonium chlorides, alkylaryl sulfonates, halophenols and phenol mercuriacetate. In the present context, the expressions “antimicrobial activity” and “antimicrobial agent” have the usual meanings as defined, for example, by K. H. Walihäuβer in “Praxis der Sterilisation, Desinfektion—Konservierung: Keimidentifizierung—Betriebshygiene” (5th Edition, Stuttgart/New York: Thieme, 1995), any of the substances with antimicrobial activity described therein being usable. Suitable antimicrobial agents are preferably selected from the groups of alcohols, amines, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propyl butyl carbamate, iodine, iodophores, peroxo compounds, halogen compounds and mixtures of the above.

The antimicrobial agent may be selected from ethanol, n-propanol, i-propanol, butane-1,3-diol, phenoxyethanol, 1,2-propylene glycol, glycerol, undecylenic acid, benzoic acid, salicylic acid, dihydracetic acid, o-phenylphenol, N-methyl morpholine acetonitrile (MMA), 2-benzyl-4-chlorophenol, 2,2′-methylene-bis-(6-bromo-4-chlorophenol), 4,4′-dichloro-2′-hydroxydiphenyl ether (Dichlosan), 2,4,4′-trichloro-2′-hydroxydiphenyl ether (Trichlosan), chlorohexidine, N-(4-chlorophenyl)-N-3,4-dichlorophenyl)-urea, N,N′-(1,10-decanediyldi-1-pyridinyl-4-ylidene)-bis-(1-octanamine)-dihydrochloride, N,N′-bis-(4-chlorophenyl)-3,12-diimino-2,4,11,13-tetraazatetradecane diimidoamide, glucoprotamines, antimicrobial surface-active quaternary compounds, guanidines, including the bi- and polyguanidines such as, for example, 1,6-bis-(2-ethylhexylbiguanidohexane)-dihydrochloride, 1,6-di-(N₁,N₁′-phenyldiguanido-N₅,N₅′)-hexane tetrahydrochloride, 1,6-di-(N₁,N₁′-phenyl-N₁,N₁-methyldiguanido-N₅,N5′)-hexane dihydrochloride, 1,6-di-(N₁,N₁′-o-chlorophenyldiguanido-N₅,N₅′)-hexane dihydrochloride, 1,6-di-(N₁,N₁′-2,6-dichlorophenyldiguanido-N₅,N₅′)-hexane dihydrochloride, 1,6-di-[N₁N₁′,-β-(p-methoxyphenyl)-diguanido-N₅,N₅′]-hexane dihydrochloride, 1,6-di-(N₁N₁′-α-methyl-β-phenyldiguanido-N₅,N5′)-hexane dihydrochloride, 1,6-di-(N₁,N₁′,-p-nitrophenyldiguanido-N₅,N₅′)-hexane dihydrochloride, ω:ω-di-(N₁,N₁′-phenyldiguanido-N₅,N₅′)-di-n-propyl ether dihydrochloride, ω:ω′-di-(N₁,N₁′-p-chlorophenyldiguanido-N₅,N₅′)-di-n-propyl ether tetrahydrochloride, 1,6-di-(N₁,N₁′-2,4-dichlorophenyldiguanido-N₅,N₅′)-hexane tetrahydrochloride, 1,6-di-(N₁,N₁′-p-methylphenyldiguanido-N₅,N₅′)-hexanedihydrochloride, 1,6-di-(N₁,N₁′-2,4,5-trichlorophenyldiguanido-N₅,N₅′)-hexane tetrahydrochloride, 1,6-di-[N₁,N₁′-α-(p-chlorophenyl)-ethyldiguanido-N₅,N₅′]-hexane dihydrochloride, ω:ω-di-(N₁,N₁′-p-chlorophenyldiguanido-N₅,N₅′)-m-xylene dihydrochloride, 1,12-di-(N₁,N₁′-p-chlorophenyldiguanido-N₅,N₅′)-dodecane dihydrochloride, 1,10-di-(N₁,N₁′-phenyldiguanido-N₅,N₅′)-decane tetrahydrochloride, 1,12-di-(N₁,N₁′-phenyldiguanido-N₅,N₅′)-dodecane tetrahydrochloride, 1,6-di-(N₁,N₁′-o-chlorophenyldiguanido-N₅,N₅′)-hexane dihydrochloride, 1,6-di-(N₁,N₁′-o-chlorophenyldiguanido-N₅,N₅′)-hexane tetrahydrochloride, ethylene-bis-(1-tolylbiguanide), ethylene-bis-(p-tolylbiguanide), ethylene-bis-(3,5-dimethylphenylbiguanide), ethylene-bis-(p-tert.amylphenylbiguanide), ethylene-bis-(nonylphenylbiguanide), ethylene-bis-(phenylbiguanide), ethylene-bis-(N-butylphenylbiguanide), ethylene-bis-(2,5-diethoxyphenylbiguanide), ethylene-bis-(2,4-dimethylphenylbiguanide), ethylene-bis-(o-diphenylbiguanide), ethylene-bis-(mixed-amylnaphthylbiguanide), N-butylethylene-bis-(phenylbiguanide), trimethylene-bis-(o-tolylbiguanide), N-butyltrimethylene-bis-(phenylbiguanide) and the corresponding salts, such as acetates, gluconates, hydrochlorides, hydrobromides, citrates, bisulfites, fluorides, polymaleates, N-cocoalkyl sarcosinates, phosphites, hypophosphites, perfluorooctanoates, silicates, sorbates, salicylates, maleates, tartrates, fumarates, ethylenediamine tetraacetates, iminodiacetates, cinnamates, thiocyanates, arginates, pyromellitates, tetracarboxybutyrates, benzoates, glutarates, monofluorophosphates, perfluoropropionates and mixtures thereof. Halogenated xylene and cresol derivatives, such as p-chloro-m-cresol or p-chloro-m-xylene, and natural antimicrobial agents of vegetable origin (for example from spices or herbs), animal and microbial origin are also suitable. Preferred antimicrobial agents are antimicrobial surface-active quaternary compounds, a natural antimicrobial agent of vegetable origin and/or a natural antimicrobial agent of animal origin and, most preferably, at least one natural antimicrobial agent of vegetable origin from the group comprising caffeine, theobromine and theophylline and essential oils, such as eugenol, thymol and geraniol, and/or at least one natural antimicrobial agent of animal origin from the group comprising enzymes, such as protein from milk, lysozyme and lactoperoxidase and/or at least one antimicrobial surface-active quaternary compound containing an ammonium, sulfonium, phosphonium, iodonium or arsonium group, peroxo compounds and chlorine compounds. Substances of microbial origin, so-called bacteriozines, may also be used. Glycine, glycine derivatives, formaldehyde, compounds which readily eliminate formaldehyde, formic acid and peroxides are preferably used.

Where the conditioner according to the invention is used as impregnating liquid for the conditioning substrates according to the invention, dehydracetic acid and glycolic acid are particularly suitable.

The quaternary ammonium compounds (QUATS) suitable as antimicrobial agents have the general formula (R¹)(R²)(R³)(R⁴)N⁺X⁻, in which R¹ to R⁴ may be the same or different and represent C₁₋₂₂ alkyl groups, C₇₋₂₈ aralkyl groups or heterocyclic groups, two or—in the case of an aromatic compound, such as pyridine—even three groups together with the nitrogen atom forming the heterocycle, for example a pyridinium or imidazolinium compound, and X⁻ represents halide ions, sulfate ions, hydroxide ions or similar anions. In the interests of optimal antimicrobial activity, at least one of the substituents preferably has a chain length of 8 to 18 and, more preferably, 12 to 16 carbon atoms.

QUATS can be obtained by reaction of tertiary amines with alkylating agents such as, for example, methyl chloride, benzyl chloride, dimethyl sulfate, dodecyl bromide and also ethylene oxide. The alkylation of tertiary amines with one long alkyl chain and two methyl groups is particularly simple. The quaternization of tertiary amines containing two long chains and one methyl group can also be carried out under mild conditions using methyl chloride. Amines containing three long alkyl chains or hydroxy-substituted alkyl chains lack reactivity and are preferably quaternized with dimethyl sulfate.

Suitable QUATS are, for example, benzalkonium chloride (N-alkyl-N,N-dimethylbenzyl ammonium chloride, CAS No. 8001-54-5), benzalkon B (m,p-dichlorobenzyl dimethyl-C₁₂-alkyl ammonium chloride, CAS No. 58390-78-6), benzoxonium chloride (benzyldodecyl-bis-(2-hydroxyethyl)-ammonium chloride), cetrimonium bromide (N-hexadecyl-N,N-trimethyl ammonium bromide, CAS No. 57-09-0), benzetonium chloride (N,N-di-methyl-N-[2-[2-[p-(1,1,3,3-tetramethylbutyl)-phenoxy]-ethoxy]-ethyl]-benzyl ammonium chloride, CAS No. 121-54-0), dialkyl dimethyl ammonium chlorides, such as di-n-decyldimethyl ammonium chloride (CAS No. 7173-51-5-5), didecyldimethyl ammonium bromide (CAS No. 2390-68-3), dioctyl dimethyl ammonium chloride, 1-cetylpyridinium chloride (CAS No. 123-03-5) and thiazoline iodide (CAS No. 15764-48-1) and mixtures thereof. Particularly preferred QUATS are the benzalkonium chlorides containing C₈₋₁₈ alkyl groups, more particularly C₁₂₋₁₄ alkyl benzyl dimethyl ammonium chloride.

Benzalkonium halides and/or substituted benzalkonium halides are commercially obtainable, for example, as Barquat® from Lonza, Marquat® from Mason, Variquat® from Witco/Sherex and Hyamine® from Lonza and as Bardac® from Lonza. Other commercially obtainable antimicrobial agents are N-(3-chloroallyl)-hexaminium chloride, such as Dowicide® and Dowicil® from Dow, benzethonium chloride, such as Hyamine® 1622 from Rohm & Haas, methyl benzethonium chloride, such as Hyamine® 10X from Rohm & Haas, cetyl pyridinium chloride, such as cepacolchloride from Merrell Labs.

In addition, the conditioners may optionally contain UV absorbers which are absorbed onto the treated textiles and improve the light stability of the fibers and/or the light stability of the other formulation ingredients. UV absorbers are organic substances (light filters) which are capable of absorbing ultraviolet rays and of releasing the energy absorbed in the form of longer-wave radiation, for example heat. Compounds which possess these desired properties are, for example, the compounds which act by radiationless deactivation and derivatives of benzophenone with substituents in the 2- and/or 4-position. Other suitable UV absorbers are substituted benzotriazole such as, for example, the water-soluble benzene-sulfonic acid-3-(2H-benzotriazol-2-yl)-hydroxy-5-(methylpropyl)-monosodium salt (Cibafast® H), 3-phenyl-substituted acrylates (cinnamic acid derivatives), optionally with cyano groups in the 2-position, salicylates, organic Ni complexes and natural substances, such as umbelliferone and the body's own urocanic acid. Particular significance attaches to the biphenyl and, above all, stilbene derivatives described, for example, in EP 0728749 A which are commercially available as Tinosorb® FD and Tinosorb® FR ex Ciba. Suitable UV-B absorbers include 3-benzylidene camphor or 3-benzylidene norcamphor and derivatives thereof, for example 3-(4-methylbenzylidene)-camphor as described in EP-B1 0693471; 4-aminobenzoic acid derivatives, preferably 4-(dimethylamino)-benzoic acid-2-ethylhexyl ester, 4-(dimethylamino)-benzoic acid-2-octyl ester and 4-(dimethylamino)-benzoic acid amyl ester; esters of cinnamic acid, preferably 4-methoxycinnamic acid-2-ethylhexyl ester, 4-methoxycinnamic acid propyl ester, 4-methoxycinnamic acid isoamyl ester, 2-cyano-3,3-phenylcinnamic acid-2-ethylhexyl ester (Octocrylene); esters of salicylic acid, preferably salicylic acid-2-ethylhexyl ester, salicylic acid-4-isopropylbenzyl ester, salicylic acid homomenthyl ester; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzmalonic acid di-2-ethylhexyl ester; triazine derivatives such as, for example, 2,4,6-trianilino-(p-carbo-2′-ethyl-1′-hexyloxy)-1,3,5-triazine and Octyl Triazone as described in EP 0818450 A1 or Dioctyl Butamido Triazone (Uvasorb® HEB); propane-1,3-diones such as, for example, 1-(4-tert.butylphenyl)-3-(4′-methoxyphenyl)-propane-1,3-dione; ketotricyclo(5.2.1.0)decane derivatives as described in EP 0694521 B1. Other suitable UV-B absorbers are 2-phenylbenzimidazole-5-sulfonic acid and alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and salts thereof; sulfonic acid derivatives of 3-benzylidene camphor such as, for example, 4-(2-oxo-3-bornylidenemethyl)-benzene sulfonic acid and 2-methyl-5-(2-oxo-3-bornylidene)-sulfonic acid and salts thereof. Typical UV-A filters are, in particular, derivatives of benzoyl methane such as, for example, 1-(4′-tert.butylphenyl)-3-(4′-methoxyphenyl)-propane-1,3-dione, 4-tert.butyl-4′-methoxydibenzoyl methane (Parsol 1789), 1-phenyl-3-(4′-isopropylphenyl)-propane-1,3-dione and the enamine compounds described in DE 19712033 A1 (BASF). The UV-A and UV-B filters may of course also be used in the form of mixtures. Besides the soluble substances mentioned, insoluble light-blocking pigments, i.e. finely dispersed, preferably “nanoized” metal oxides or salts, may also be used for this purpose. Examples of suitable metal oxides are, in particular, zinc oxide and titanium dioxide and also oxides of iron, zirconium oxide, silicon, manganese, aluminium and cerium and mixtures thereof. Silicates (talcum), barium sulfate and zinc stearate may be used as salts. The oxides and salts are used in the form of the pigments for skin-care and skin-protecting emulsions and decorative cosmetics. The particles should have a mean diameter of less than 100 nm, preferably between 5 and 50 nm and more preferably between 15 and 30 nm. They may be spherical in shape although ellipsoidal particles or other non-spherical particles may also be used. The pigments may also be surface-treated, i.e. hydrophilicized or hydrophobicized. Typical examples are coated titanium dioxides, for example Titandioxid T 805 (Degussa) and Eusolex® T2000 (Merck). Suitable hydrophobic coating materials are, above all, silicones and, among these, especially trialkoxyoctylsilanes or simethicones. Micronized zinc oxide is preferably used. Other suitable UV filters can be found in P. Finkel's review in SÖFW-Journal 122, 543 (1996).

The UV absorbers are normally used in quantities of 0.01% by weight to 5% by weight and preferably 0.03% by weight to 1% by weight.

In a second embodiment, the present invention relates to the use of the conditioners according to the invention for conditioning textile fabrics in a laundry drying process or in a washing process.

The use in accordance with the invention of the conditioners according to the invention in a washing process may take place directly, for example by integration of the conditioner according to the invention in a detergent formulation and/or preferably in a fabric softening cycle following the washing process. The conditioners according to the invention may advantageously be used in a laundry drying process in an appliance for drying laundry, for example in a household laundry dryer. In a preferred embodiment, the conditioner according to the invention is contacted with the textiles to be conditioned in the final rinse cycle via the dispensing drawer of an automatic washing machine.

In a third embodiment, the present invention relates to a conditioning substrate which is a substrate impregnated with the conditioner according to the invention.

The substrate material consists of porous materials which are capable of reversibly absorbing and releasing an impregnating liquid. Both three-dimensional structures, for example sponges, but preferably porous sheets are suitable for this purpose. They may consist of a fibrous or cellular flexible material which is sufficiently heat-resistant to be used in the dryer and which is capable of retaining sufficient quantities of an impregnating or coating composition for effectively conditioning fabrics without the conditioner significantly running or bleeding out during storage. Such sheets include sheets of woven and nonwoven synthetic and natural fibers, felt, paper or foam, such as hydrophilic polyurethane foam. Conventional sheets of nonwoven material (fleeces) are preferably used. Fleeces are generally defined as adhesive-bonded fibrous products which comprise a mat or coated fiber structure or products which include fiber mats where the fibers are distributed at random or statistically. The fibers may be natural, such as wool, silk, jute, hemp, cotton, linen, sisal or ramie, or synthetic, such as rayon, cellulose esters, polyvinyl derivatives, polyolefins, polyamides, viscose or polyester. In general, any fiber diameter or denier is suitable for the present invention. Preferred conditioning substrates according to the invention consist of a fleece containing cellulose. By virtue of the random or statistical arrangement of fibers in the nonwoven materials which impart excellent strength in all directions, the nonwoven materials used in this case show no tendency to tear or disintegrate when used, for example, in a commercially available laundry dryer. Examples of nonwoven materials suitable as substrates for the purposes of the present invention are known, for example, from WO 93/23603. Preferred porous conditioning sheets consist of the same or different fibrous materials, more particularly of cotton, treated cotton, polyamide, polyester or blends thereof. The conditioning substrates in sheet form preferably have a surface area of 0.2 to 0.005 m², preferably 0.15 to 0.01 m², more preferably 0.1 to 0.03 cm² and most preferably 0.09 to 0.06 m². Their weight per unit area is normally between 20 and 500 g/m², preferably between 25 and 200 g/m², more preferably between 30 and 100 g/m² and most preferably between 40 and 80 g/m².

A fourth embodiment of the invention is a conditioning process for conditioning damp textiles using the conditioning substrate according to the invention.

The conditioning process is carried out by introducing the conditioning substrate according to the invention into a laundry drying process together with damp laundry emanating, for example, from a preceding washing process. The laundry drying process normally takes place in a machine for drying fabrics, preferably in a household laundry dryer.

Accordingly, a fifth embodiment is the use of the conditioners according to the invention and/or the conditioning substrates according to the invention for reducing the fluff formation of fabrics. The present invention also relates to the use of the conditions according to the invention and/or the conditioning substrates according to the invention for reducing the pilling of fabrics.

Fluff is formed by the breakage of fibers on textile surfaces. The fiber fragments collect on the fluff filter of a domestic dryer, being transported by the air stream to the fluff filter. Pilling takes place similarly. Pills are more or less spherical structures which are connected by anchor fibers to the textile surface and of which the density is such that no light penetrates and a shadow is formed. This change can occur both during washing and during wear. Pills are formed when fibers work themselves out of a textile material and become entangled in use. Such surface changes are undesirable. In general, the degree of pilling is determined by the speed of the following processes which take place parallel to one another: a) fiber entanglement which results in pilling; b) formation of other surface fibers and c) abrasion of fibers and pills.

### EXAMPLES

Conditioners according to the invention are, for example, E1 and E2 while a Comparison Formulation is C1 of which the compositions are shown in Table 1.

TABLE 1

| Composition in % | | | | | |
|---|---|---|---|---|---|
| by weight | E1 | E2 | E3 | E4 | C1 |
| Rewoquat WE 18^{[a]} | 22.5 | 22.5 | 22.5 | 22.5 | 22.5 |
| Silicone oil^{[b]} | 5 | — | — | — | — |
| Tegopren 5843^{[c]} | 0.75 | 0.75 | 0.75 | 0.75 | — |
| MgCl₂.6 H₂O | 0.5 | 0.5 | 0.5 | 0.5 | 0.5 |
| Plexophor-Eco^{[d]} | — | 5.0 | — | — | — |
| Arbocel ® BE 600-10^{[e]} | — | — | 5.0 | — | — |
| Cellulon ®^{[f]} | — | — | — | 0.4 | — |
| Perfume | 1.6 | 1.6 | 1.6 | 1.6 | + |
| Dye | + | + | + | + | + |
| Water, deionized | to 100 | to 100 | to 100 | to 100 | to 100 |

^{[a]}N-methyl-N-(2-hydroxyethyl)-N,N-(ditallowacyloxyethyl)-ammonium methosulfate ex Stepan
^{[b]}Silicone oil ex Ciba
^{[c]}Polyether-modified polysiloxane ex Goldschmidt
^{[d]}Acrylic acid/maleic acid copolymer (MW: 18,000)
^{[e]}Microcrystalline cellulose (mean fiber length 18 m) ex Rettenmaier
^{[f]}Biotechnologically produced microcellulose ex Kelco

Formulations E1 to E4 were produced by melting the esterquat in water. The molten esterquat was then stirred with an intensive disperser and the remaining active substances were added. The perfume was added after cooling of the mixture to below 30° C.

To produce conditioning substrates according to the invention, cellulose fleeces (measuring 24.5 cm×39 cm) were impregnated with 20 g of a conditioner E1 to E4 according to the invention. A comparison substrate was similarly produced using formulation C1.

Fluff Formation and Pilling

3.5 kg dry laundry consisting of 6 terry towels, 8 pillows, 5 tea towels, 2 m white 100% CO woven fabric (shirt quality), 2 m white 100% PES microfiber woven fabric, 2 m white 100% PES microfiber Jersey, 50 cm white 50% CO/50% poplin blend, 2 m white 100% CO single Jersey and 2 pairs of pants was washed with tower powder at 30° C. in an automatic washing machine (Miele Novotronic W 985; normal wash program 30° C.) and then dried in a household dryer (Miele Electronic T 352 C; cupboard-dry, easy-care). After drying, the previously tared fluff filter of the dryer was weighed out. The washing/drying/weighing cycles were repeated 10 times under the following conditions:

a) the laundry was dried without conditioning substrate

b) the laundry was loaded into the dryer with a conditioning substrate

c) the laundry was loaded into the dryer with a conditioning substrate E1

d) the laundry was loaded into the dryer with a conditioning substrate E2

e) the laundry was loaded into the dryer with a conditioning substrate E3

f) the textiles were loaded into the dryer with a conditioning substrate E4

The weight of the fluff was determined after each drying cycle and totalled over the 10 cycles. The following values were obtained: 7.58 g for a), 8.39 g for b), 4.05 g for c), 5.51 g for d), 4.17 g for e) and 6.21 g for f). Fluff formation is thus considerably reduced and fabric care ensured by the use of the conditioning substrates according to the invention.

Pilling tests were carried out under the same conditions as described above. The tests were carried out to DIN EN ISO 12945, Part 2 “Determination of the tendency of textiles towards surface fluff formation and pilling” using a Martindale Model 404 abrasion and pilling tester. The tests were carried out in an air-conditioned room (textile climate 20° C./65% relative air humidity). The principle of the Martindale Test is to rub the test specimen against a defined weight in a constantly changing movement which ensures that the surface fibers of the specimens are bent in all directions. The pills formed on the surface of the test specimens are evaluated after a particular number of cycles by visual comparison with a standard set. The abrasive disks 140 mm in diameter are fixed tight over the abrasion surface with standard felt disks underneath. The test specimens (140 mm in diameter) are fixed in special specimen holders and placed with the right hand side towards the “counter”-textile. The guide plate of the Martindale tester is located above and weighted spindles are inserted through the guide plate into the underlying specimen holder. The drive mechanism consists of two outer and one inner drive which forces the guide plate of the specimen holder to describe a Lissajous figure. The Lissajous movement changes into a circular movement and then into gradually narrowing ellipses until it becomes a straight line from which progressively widening ellipses develop in a diagonally opposite direction before the pattern is repeated.

The degree of pilling is determined by comparing the test specimen with prepared photographs of standard fabrics.

The measurement showed that the pilling of textiles treated with conditioning substrates c), d), e) and f) according to the invention is distinctly reduced by comparison with the samples of a) and b).

Comparable results were observed when 36 ml of the conditioners according to the invention were applied to the textiles to be conditioned via the dispensing drawer of an automatic washing machine. The textiles treated with the comparison formulation C1 showed much greater fluff formation and pilling.

1. A liquid fabric conditioner comprising at least one fluff-reducing component, the fluff-reducing component comprising one or both fine polymer particles wherein at least 90% of the particles have a particle size below 100 μm or emulsified silicone oil having a mean emulsion droplet size below 50 μm.

2. The liquid fabric conditioner of claim 1, wherein at least 90% of the particles have a particle size below 50 μm.

3. The liquid fabric conditioner of claim 2, wherein at least 90% of the particles have a particle size below 30 μm.

4. The liquid fabric conditioner of claim 3, wherein at least 90% of the particles have a particle size below 20 μm.

5. The liquid fabric conditioner of claim 1, wherein the fine polymer particles comprise one or more polymers selected from the group consisting of cellulose, cellulose derivatives, biological polymers, and synthetic polymers.

6. The liquid fabric conditioner of claim 5, wherein the cellulose comprises microcrystalline cellulose.

7. The liquid fabric conditioner of claim 6, wherein fine polymer particles comprise one or more biological polymers in hydrogel form.

8. The liquid fabric conditioner of claim 7, wherein the one or more biological polymers are selected from the group consisting of agarose, gelatine, curdlan, alginates, pectinates, carrageenan, and mixtures thereof.

9. The liquid fabric conditioner of claim 5, wherein the synthetic polymers comprise one or more polymers selected from the group consisting of polycarboxylates, polyacrylates, polymethacrylates, polyacrylamides, polymethacrylamides, polyurethanes, polyvinyl pyrrolidones, polyvinyl alcohols, polyvinyl acetate, partial hydrolyzates thereof, and copolymers thereof.

10. The liquid fabric conditioner of claim 9, wherein the synthetic polymers comprise copolymers of acrylic acid, maleic acid, and mixtures thereof.

11. The liquid fabric conditioner of claim 5, wherein the fine polymer particles comprise one or more synthetic polymers in hydrogel form.

12. The liquid fabric conditioner of claim 1, comprising 0.005% to 15% by weight of the fluff-reducing component.

13. The liquid fabric conditioner of claim 12, comprising 0.01% to 10% by weight of the fluff-reducing component.

14. The liquid fabric conditioner of claim 13, comprising 0.1% to 7% by weight of the fluff-reducing component.

15. The liquid fabric conditioner of claim 14, comprising 0.5% to 5% by weight of the fluff-reducing component.

16. The liquid fabric conditioner of claim 1, further comprising at least one fabric-softening component.

17. The liquid fabric conditioner of claim 9, wherein the fabric-softening component comprises one or more cationic surfactants.

18. The liquid fabric conditioner of claim 17, wherein the one or more cationic surfactants comprise one or more alkylated quaternary ammonium compounds of which at least one alkyl chain is interrupted by an ester group, an amino group, or both.

19. The liquid fabric conditioner of claim 18, wherein the one or more alkylated quaternary ammonium compounds comprise one or both of N-methyl-N-(2-hydroxyethyl)-N,N-(ditallowacyloxyethyl)-ammonium methosulfate or N-methyl-N-(2-hydroxyethyl)-N,N-(dipalmitoylethyl)-ammonium methosulfate.

20. The liquid fabric conditioner of claim 16, comprising up to 50% by weight of the fabric-softening component.

21. The liquid fabric conditioner of claim 20, comprising 0.1% to 45% by weight of the fabric-softening component.

22. The liquid fabric conditioner of claim 21, comprising 5% to 40% by weight of the fabric-softening component.

23. The liquid fabric conditioner of claim 22, comprising 11% to 35% by weight of the fabric-softening component.

24. The liquid fabric conditioner of claim 16, further comprising one or more nonionic surfactants.

25. The liquid fabric conditioner of claim 16, wherein the non-ionic surfactant or surfactants comprise one or more C₈₋₁₈ alcohols containing 1 to 12 EO.

26. The liquid fabric conditioner of claim 24, further comprising a spreading agent.

27. The liquid fabric conditioner of claim 26, wherein the spreading agent comprises a polyether-modified siloxane.

28. The liquid fabric conditioner of claim 27, comprising up to 10% by weight of the spreading agent.

29. The liquid fabric conditioner of claim 28, comprising 0.01% to 5% by weight of the spreading agent.

30. The liquid fabric conditioner of claim 29, comprising 0.05% to 2% by weight of the spreading agent.

31. The liquid fabric conditioner of claim 30, comprising 0.1% to 1% by weight of the spreading agent.

32. A method of treating a textile comprising the steps of contacting a textile in a drying or washing process with an amount of the composition of claim 1 effective to reduce or prevent formation of fluff or pills on the textile.

33. A conditioning substrate impregnated with the liquid fabric conditioner of claim 1.

34. The conditioning substrate of claim 33, wherein the substrate comprises a fleece material.

35. The conditioning substrate of claim 34, wherein the fleece comprises cellulose fleece.

36. The conditioning substrate of claim 33, wherein the substrate has a weight per unit area of 20 g/m² to 500 g/m².

37. The conditioning substrate of claim 36, wherein the substrate has a weight per unit area of 25 g/m² to 200 g/m².

38. The conditioning substrate of claim 37, wherein the substrate has a weight per unit area of 30 g/m² to 100 g/m².

39. The conditioning substrate of claim 38, wherein the substrate has a weight per unit area of 40 g/m² to 80 g/m².

40. The conditioning substrate of claim 39, wherein the substrate has an area of 0.2 m² to 0.005 m².

41. The conditioning substrate of claim 40, wherein the substrate has an area of 0.15 m² to 0.01 m².

42. The conditioning substrate of claim 41, wherein the substrate has an area of 0.1 m² to 0.03 m².

43. The conditioning substrate of claim 42, wherein the substrate has an area of 0.09 m² to 0.06 m².

44. A fabric conditioning process, comprising the steps of contacting a textile in a textile drying process with the substrate of claim 33 for a time effective to reduce or prevent formation of fluff or pills on the textile.

45. The use of the liquid fabric conditioner claimed in any of claims 1 to 15 and/or the conditioning substrate claimed in any of claims 17 to 20 for reducing the fluff formation of textiles.
